(19) United States
(12) Patent Application Publication
(10) Pub. No.: US 2017/0115600 A1
(43) Pub. Date: Apr. 27, 2017

(54) SEAL CONFIGURATION FOR TONER CARTRIDGE

(71) Applicant: CLOVER TECHNOLOGIES GROUP, LLC, Ottawa, IL (US)

(72) Inventors: Robert M. Westbrook, Sugar Grove, IL (US); Erwin Vincent Penaverde, LaSalle, IL (US)

(21) Appl. No.: 15/299,086

(22) Filed: Oct. 20, 2016

Related U.S. Application Data
(60) Provisional application No. 62/245,091, filed on Oct. 22, 2015.

(51) Int. Cl. G03G 15/08

(52) U.S. Cl. CPC G03G 15/0882

(57) ABSTRACT

A toner cartridge includes a hopper section for storing toner. The hopper section defines a toner opening for dispensing toner during print operations, and at least partially defines a laser port. A developer roller is rotatably supported by the hopper section, and a doctor blade engages the developer roller. A toner seal includes a seal portion positioned between the developer roller and the toner opening, and a pull portion extending from the seal portion and through the laser port to facilitate removal of at least a portion of the toner seal from the toner cartridge by pulling the pull portion to pull at least the portion of the toner seal through the laser port.

### BACKGROUND

This application claims the benefit of and priority to U.S. Provisional Patent Application No. 62/245,091, filed Oct. 22, 2015, the entire contents of which are hereby incorporated by reference herein.

The present disclosure relates to consumable cartridges used in image forming apparatuses, and more specifically to a configuration for a toner seal used in such consumable cartridges to reduce leakage of toner from the cartridge during shipping.

Toner cartridges are frequently provided with toner seals that cover a toner opening provided in the toner hopper through which toner is dispensed during operation of the cartridge. These seals are removable either manually by a user or by a mechanism included in the toner cartridge or the image forming apparatus into which it is installed just prior to the toner cartridge being used for a printing operation. The primary function of the seal is to prevent toner from leaking out of the toner opening of the cartridge during transportation and shipping of the toner cartridge.

### SUMMARY

In some aspects, a toner cartridge includes a hopper section for storing toner. The hopper section defines a toner opening for dispensing toner during print operations, and at least partially defines a laser port. A developer roller is rotatably supported by the hopper section, and a doctor blade engages the developer roller. A toner seal includes a seal portion positioned between the developer roller and the toner opening, and a pull portion extending from the seal portion and through the laser port to facilitate removal of at least a portion of the toner seal from the toner cartridge by pulling the pull portion to pull at least the portion of the toner seal through the laser port.

The toner cartridge may also include a resilient sealing material positioned between the doctor blade and the hopper section and configured to permit removal of the toner seal from between the doctor blade and the hopper section. The seal portion may be substantially rectangular and each edge of the seal portion may be sealed to a respective edge of the toner opening. The toner seal may be secured to the hopper section with a release adhesive, and the entire toner seal may be removed from between the doctor blade and the hopper section by pulling the pull portion. The seal portion may include a fixed portion that remains fixed to walls that define the toner opening. The seal portion may also include a removable portion to which the pull portion may be attached such that pulling on the pull portion separates the removable portion from the fixed portion and pulls the removable portion through the laser port.

In other aspects, a seal configuration for a toner cartridge including a toner opening and a laser port may be provided. The seal configuration may include a seal portion configured to extend over the toner opening to substantially seal the toner opening, and a pull portion coupled to and extending away from the seal portion. The pull portion may be configured to extend through the laser port to facilitate removal of at least a portion of the seal portion from the toner opening by pulling the pull portion to pull at least the portion of the seal portion through the laser port.

The seal portion may be substantially rectangular and each edge of the seal portion may be configured to be sealed to a respective edge of the toner opening. A release adhesive may be configured to secure the toner seal to the toner cartridge, and the entire toner seal may be configured to be removed from the toner cartridge by pulling the pull portion. The seal portion may alternatively include a fixed portion configured to remain fixed to the toner cartridge and a removable portion to which the pull portion is attached such that pulling on the pull portion separates the removable portion from the fixed portion and pulls the removable portion through the laser port.

In still other aspects, a toner cartridge remanufacturing method may be provided and may include providing a used toner hopper defining a toner opening and at least partially defining a laser port, and applying a seal assembly to the toner hopper. Applying the seal assembly may include covering the toner opening with a seal portion of the seal assembly and extending a pull portion of the seal assembly through the laser port.

The used toner hopper may include a sealing rib extending substantially parallel to the toner opening, and the method may further include removing at least a portion of the sealing rib. A resilient sealing material may be installed in place of the removed portion of the sealing rib. The toner cartridge may include a doctor blade, and the method may further comprise removing the doctor blade before applying the seal assembly to the toner hopper; and reinstalling the doctor blade after applying the seal assembly to the toner hopper. The method may further include removing a developer roller before removing the doctor blade, and reinstalling the developer roller after reinstalling the doctor blade.

### BRIEF DESCRIPTION OF THE DRAWINGS

FIG. 1 is a perspective view of a toner cartridge including a seal configuration according to one embodiment.

FIG. 2 is an exploded perspective view of the toner cartridge of FIG. 1.

FIG. 3 is a perspective view of a hopper section of the toner cartridge of FIG. 1.

FIG. 4 is a perspective view of the hopper section of FIG. 3 modified to accommodate a seal configuration according to one embodiment.

FIG. 5 is a perspective view of the hopper section of FIG. 4 with a seal assembly overlying the toner opening.

FIG. 6 is a perspective view of the hopper section and seal assembly of FIG. 5 with a doctor blade installed over a portion of the seal assembly.

FIGS. 7A, 7B, and 7C illustrate the seal assembly being removed from the hopper section.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting.

### DETAILED DESCRIPTION

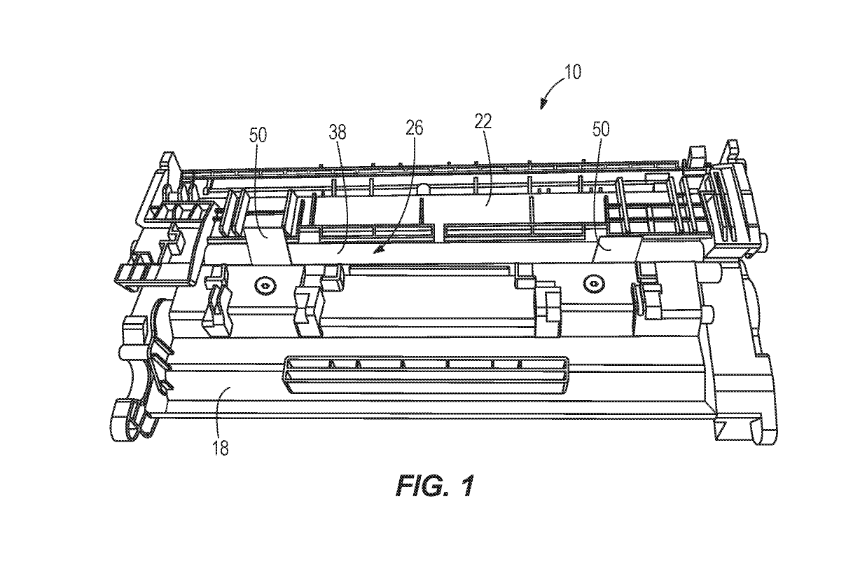

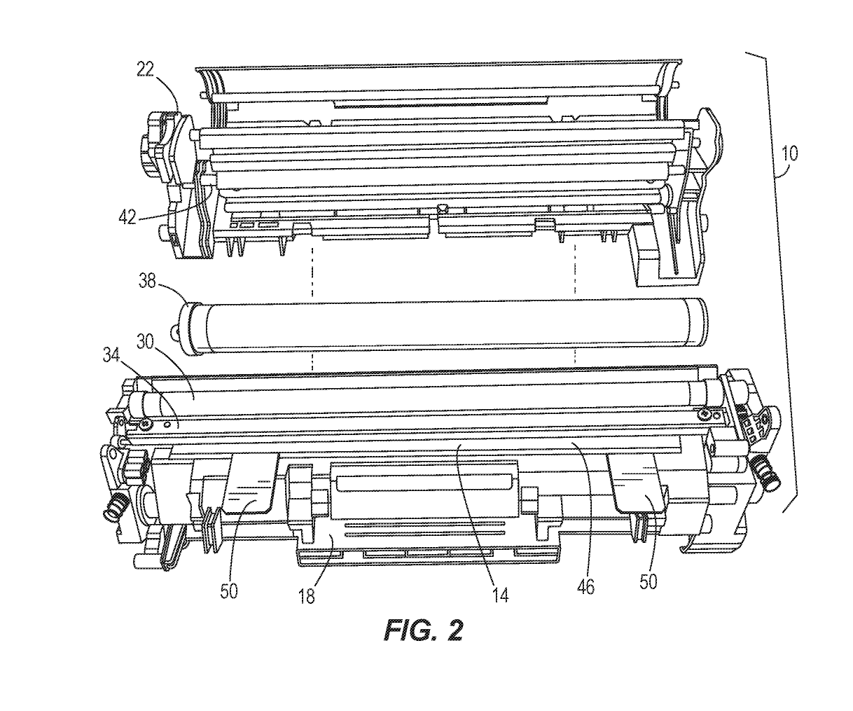

FIGS. 1 and 2 illustrate a toner cartridge 10 and seal assembly 14 according to one embodiment of the present invention. The toner cartridge 10 includes a hopper section 18 configured to hold a charge of toner to be used during printing operations, and a waste bin section 22 configured to hold waste toner that remains with the cartridge 10 following printing operations. In the illustrated exemplary cartridge 10 configuration the hopper section 18 and the waste bin section 22 cooperate to define a longitudinally extending and generally rectangularly-shaped laser port 26 (FIG. 1) through which the laser of an image forming apparatus shines during printing operations. In other cartridge configurations, the laser port 26 may be defined exclusively by the hopper section 18, exclusively by the waste bin section 22, or by other cartridge components either alone or in combination with one or both of the hopper section 18 and the waste bin section 22.

The hopper section 18 rotatably supports a developer roller 30 and fixedly supports a doctor blade 34 that engages the developer roller 30. The developer roller 30 and doctor blade 34 cooperate in a known manner to deliver a metered amount of toner to a photosensitive drum 38 that is rotatably supported by the waste bin section 22. The waste bin section 22 also rotatably supports a primary charge roller 42 that engages and rotates with the photosensitive drum 38 and applies a uniform charge thereto during printing operations. The seal assembly 14 includes a seal portion 46 extending in the longitudinal direction of the cartridge 10 and positioned beneath the doctor blade 34 and the developer roller 30. The seal assembly 14 also includes a pull portion 50 coupled to and extending away from the seal portion 46. The pull portion 50 extends away from the seal portion 46 at an angle (e.g., a right angle, as illustrated) such that the pull portion 50 extends through the laser port 26 in the assembled cartridge (see FIG. 1).

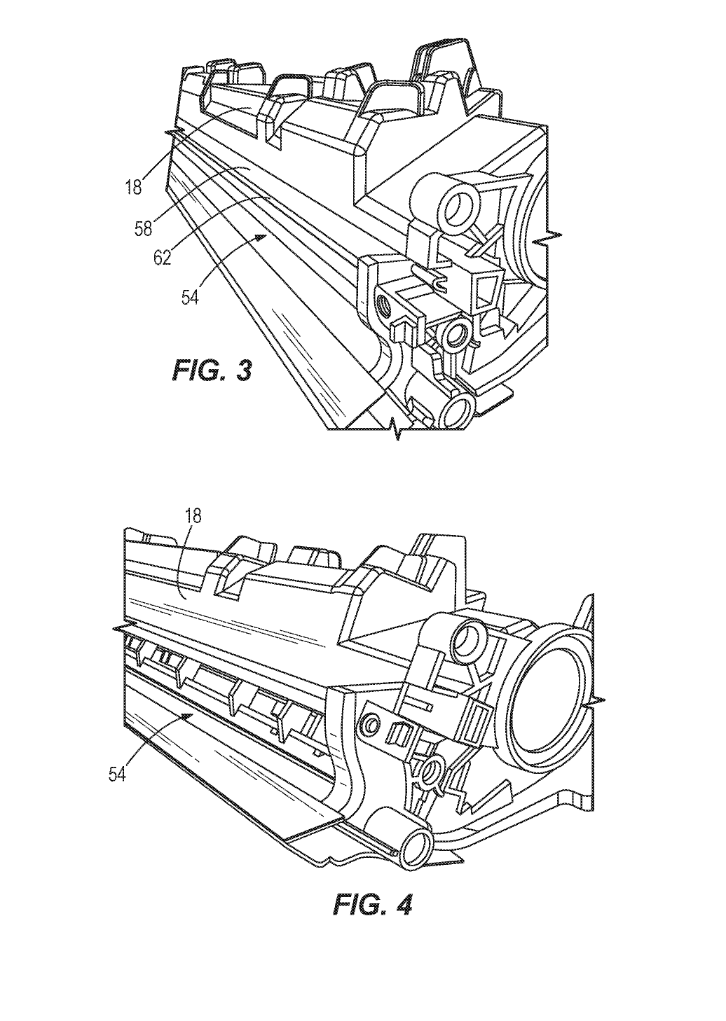

Referring also to FIGS. 3 and 4, in some embodiments or configurations, the seal assembly 14 may be used as part of a toner cartridge remanufacturing process and the hopper section 18 of the toner cartridge 10 may require modification to accommodate the seal. In the exemplary configuration of FIGS. 3 and 4, the hopper section 18 includes a toner opening 54 extending in the longitudinal direction of the cartridge. As understood by those skilled in the art, at least a portion of the developer roller 30 is at least partially positioned within the toner opening 54 to receive toner therefrom. To begin the remanufacturing process the hopper section 18 is separated from the waste bin section 22, and the developer roller 30 and the doctor blade 34 are removed. In the illustrated configuration, a sealing rib 58 extends substantially parallel to the toner opening 54 and includes a silicone bead 62 along its free end that provides a seal between the hopper section 18 and the doctor blade 34. In some embodiments, the sealing rib 58 is at least partially removed from the hopper section 18, for example by milling, cutting, or the like, as shown in FIG. 4, such that the pull portion 50 of the seal assembly 14 can extend between the doctor blade 34 and the hopper section 18 toward the laser port 26. To maintain a suitable seal between the doctor blade 34 and the hopper section, foam or other sealing materials may be installed in place of the removed sealing rib 58. Such foam or other sealing materials will simultaneously permit the seal assembly 14 to be removed in the manner described below while also reducing or eliminating the leakage of toner between hopper section 18 and the doctor blade 34. Once the foam or other sealing material is in place the seal assembly 14 may be applied to the toner opening 54. With the pull portion 50 of the seal assembly 14 extending toward the laser port 26, the doctor blade 34 may be reinstalled. With the doctor blade 34 in place the developer roller 30 may be reinstalled and the hopper section 18 may be reconnected to or with the waste bin section 22. It should be appreciated that additional remanufacturing processes may also be carried out during installation of the seal assembly 14, including but not limited to refilling the hopper section 18 with toner and replacing the photosensitive drum 38.

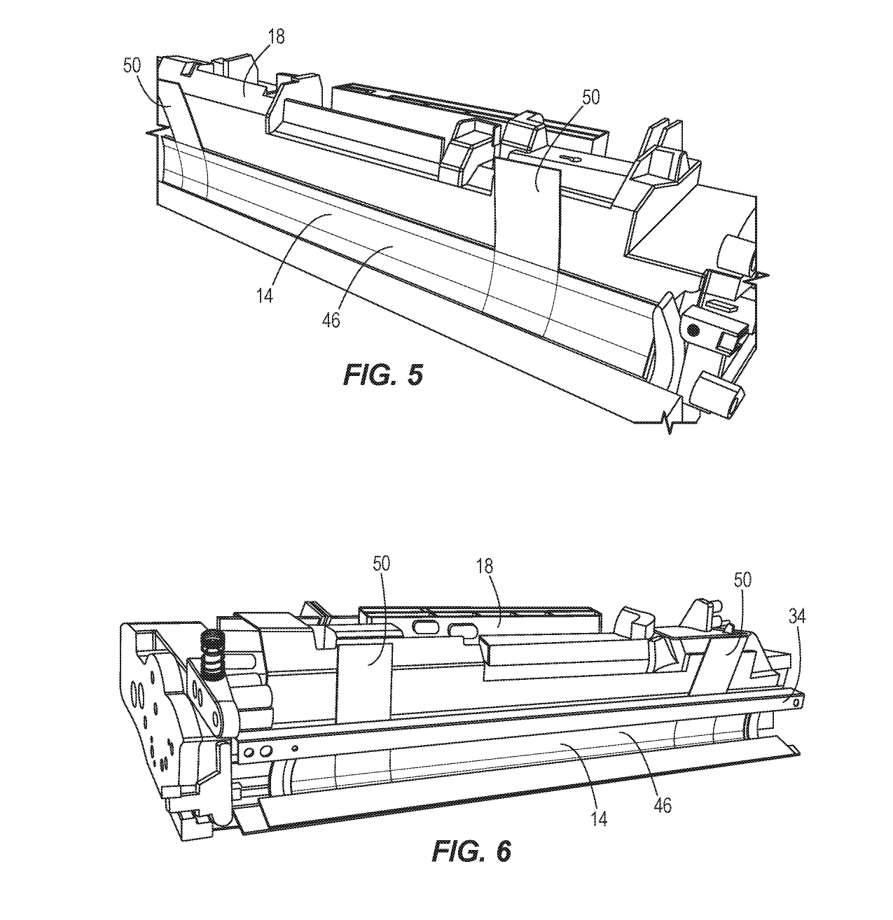

FIG. 5 illustrates the seal assembly 14 positioned to cover the toner opening 54. The seal portion 46 of the seal assembly 14 is substantially rectangular and each edge of the seal assembly 14 is sealed to a respective edge of the toner opening 54. In some embodiments, the seal portion 46 may be secured to the toner opening 54 using a release adhesive that allows the entire seal portion 46 to be removed from the toner opening 54. In other embodiments, the seal portion 45 may be perforated, die cut, or otherwise manufactured to have a fixed portion that remains permanently fixed to the walls that define the toner opening, and a removable portion to which the pull portion(s) 50 are attached and which is removed or separated from the fixed portion to open the toner opening 54 before using the cartridge. Although two pull portions 50 are shown in the illustrated embodiment, more or fewer pull portions 50 may also be used and may be configured in a variety of ways to facilitate removal or opening of the seal portion 46.

FIG. 6 illustrates the seal assembly positioned to cover the toner opening 54 and with the doctor blade 34 installed onto the hopper section 18. As noted above, foam or other resilient sealing materials may be positioned between the doctor blade 34 and the hopper section to prevent toner leakage while also permitting removal of the seal assembly 14 from the hopper section 18.

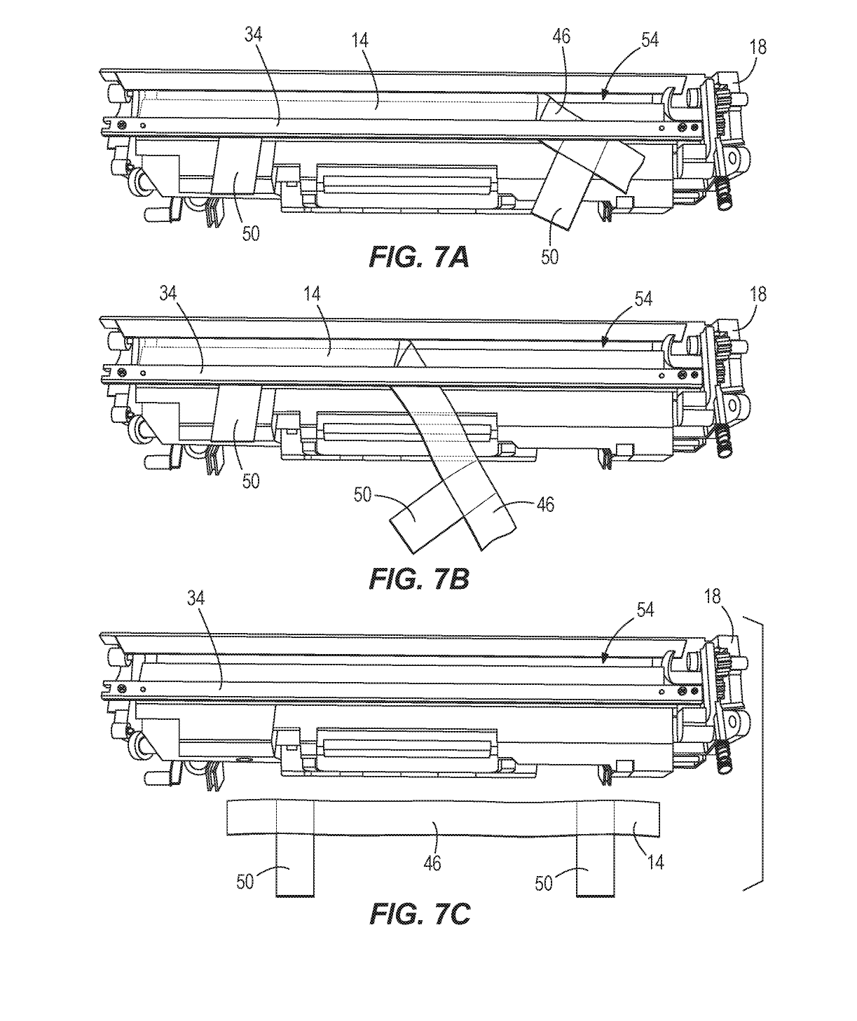

FIGS. 7A, 7B, and 7C illustrate one exemplary process of removing the seal assembly 14 from the hopper section. For clarity, FIGS. 7A, 7B, and 7C do not include or show the waste bin section 22 of the toner cartridge 14. It should be appreciated however, including by reference to FIG. 1, that the pull portions 50 of the seal assembly 14 extend through the laser port 26 of the assembled cartridge 10 in ordinary usage. As shown in FIG. 7A, pulling one of the pull portions 50 releases the corresponding end of the seal portion 46 from the toner opening 54 and also pulls the corresponding end of the seal portion 46 through the clearance that is provided between the doctor blade 34 and the hopper section 18 by the foam or other sealing material positioned between the doctor blade 34 and the hopper section 18. Continued pulling of the pull portion 50 pulls the entire seal portion 46 through the space between the doctor blade 34 and the hopper section 18 and through the laser port 26 of the cartridge 10 until the entire seal portion 46 has been removed, thereby opening the toner opening 54 and allowing the cartridge to operate normally when installed into an image forming apparatus.

Various features of the invention are set forth in the following claims.

What is claimed is:

1. A toner cartridge comprising:
a hopper section for storing toner, the hopper section defining a toner opening for dispensing toner during print operations, and at least partially defining a laser port;
a developer roller rotatably supported by the hopper section;
a doctor blade engaging the developer roller; and
a toner seal including a seal portion positioned between the developer roller and the toner opening and a pull portion extending from the seal portion and through the laser port to facilitate removal of at least a portion of the toner seal from the toner cartridge by pulling the pull portion to pull at least the portion of the toner seal through the laser port.

2. The toner cartridge of claim 1, further comprising a resilient sealing material positioned between the doctor blade and the hopper section and configured to permit removal of the toner seal from between the doctor blade and the hopper section.

3. The toner cartridge of claim 1, wherein the seal portion is substantially rectangular and wherein each edge of the seal portion is sealed to a respective edge of the toner opening.

4. The toner cartridge of claim 1, wherein the toner seal is secured to the hopper section with a release adhesive, and wherein the entire toner seal is removed from between the doctor blade and the hopper section by pulling the pull portion.

5. The toner cartridge of claim 1, wherein the seal portion includes a fixed portion that remains fixed to walls that define the toner opening, and a removable portion to which the pull portion is attached, and wherein pulling on the pull portion separates the removable portion from the fixed portion and pulls the removable portion through the laser port.

6. A seal configuration for a toner cartridge including a toner opening and a laser port, the seal configuration comprising:
a seal portion configured to extend over the toner opening to substantially seal the toner opening; and
a pull portion coupled to and extending away from the seal portion, the pull portion configured to extend through the laser port to facilitate removal of at least a portion of the seal portion from the toner opening by pulling the pull portion to pull at least the portion of the seal portion through the laser port.

7. The seal configuration of claim 6, wherein the seal portion is substantially rectangular and wherein each edge of the seal portion is configured to be sealed to a respective edge of the toner opening.

8. The seal configuration of claim 6, further comprising a release adhesive configured to secure the toner seal to the toner cartridge, and wherein the entire toner seal is configured to be removed from the toner cartridge by pulling the pull portion.

9. The seal configuration of claim 6, wherein the seal portion includes a fixed portion configured to remain fixed to the toner cartridge and a removable portion to which the pull portion is attached, and wherein pulling on the pull portion separates the removable portion from the fixed portion and pulls the removable portion through the laser port.

10. A toner cartridge remanufacturing method comprising:
providing a used toner hopper defining a toner opening and at least partially defining a laser port; and, applying a seal assembly to the toner hopper, including covering the toner opening with a seal portion of the seal assembly and extending a pull portion of the seal assembly through the laser port.

11. The method of claim 10, wherein the used toner hopper includes a sealing rib extending substantially parallel to the toner opening, the method further comprising removing at least a portion of the sealing rib.

12. The method of claim 11, further comprising installing a resilient sealing material in place of the removed portion of the sealing rib.

13. The method of claim 11, wherein the toner cartridge includes a doctor blade, the method further comprising removing the doctor before applying the seal assembly to the toner hopper; and reinstalling the doctor blade after applying the seal assembly to the toner hopper.

14. The method of claim 13, further comprising removing a developer roller before removing the doctor blade, and reinstalling the developer roller after reinstalling the doctor blade.
